(19) United States
(12) Patent Application Publication
(10) Pub. No.: US 2007/0035500 A1
(43) Pub. Date: Feb. 15, 2007

(54) DATA BUS STRUCTURE AND DRIVING METHOD THEREOF

(76) Inventors: Keisuke Takeo, Ibaraki Pref (JP); Yasuhiro Gen, Saitama Pref (JP); Masahiro Kaneko, Saitama Pref (JP); Hitoshi Oikawa, Kanagawa Pref (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,646

(22) Filed: Aug. 11, 2005

(51) Int. Cl. G09G 3/36

(52) U.S. Cl. 345/98

(57) ABSTRACT

A data bus structure, a driver therewith, and a display with a driver capable of low power consumption are provided herewith. In the proposed structure, data lines of the data bus corresponding to a plurality of output channels are divided by alternatively inserting isolating elements. By controlling these isolating elements, current will be alternatively isolated from a portion of the bus and power consumption is significantly reduced. In the proposed structure, different function and settings can be determined in advance in consideration of where data is taken into the bus line.

### BACKGROUND OF THE INVENTION

1. Field of Invention

The invention relates to a data bus structure and a driving method thereof. More particularly, the invention provides a data bus structure and a driving for a display driver, which is capable of low power consumption.

2. Description of Related Art

In general, a driver circuit for a liquid crystal display (LCD) includes a gate driver and a data driver. The data driver is utilized to transfer image data to displaying area of a display panel in the LCD. The conventional data bus of the data driver is a long data bus drawn toward a long side of the LCD, and a length of the data bus nearly equals to the length of the LCD itself. In a normal LCD display, for example, there are more than 384 latch circuits connected to the data bus. The data bus is swung at the same timing with clock while data is taken into the latch circuits in turn under the control of shift registers connected thereto. The unnecessary part of the data bus, to which data is not taken into the latch circuits connected, is swung all the time. In addition, the number of data bus tends to increase for increasing gray scale as required. It means that there is more power lost in vain, and the total vain power loss will be dramatically increased. Therefore, a data bus for LCD driver with improved power consumption is highly demanded.

### SUMMARY OF THE INVENTION

The present invention provides a data bus structure and a driving method for a display driver, which is capable of low power consumption.

In the proposed structure and driving method therewith, data lines corresponding to a plurality of output channels are divided by alternatively inserting isolating elements. By controlling these isolating elements, current will be alternatively isolated from a portion of the bus and power consumption is significantly reduced. In the proposed structure, different function and settings can be determined in advance in consideration of where data is taken into the bus line.

The data bus structure can be implemented by several embodiments, according to the design choice and requirement. In an alternative embodiment, the data line is divided into several sections by inserting the isolating elements according to the interconnection positions between the data line and every M channels, M is determined as required. In another alternative embodiment, the position where the data is applied to the bus lines are considered to adjust the arrangement of the isolating elements inserted in the bus lines, for example, the data applied to the bus lines is to a center portion, to a left portion or to a right portion of the bus lines. In another alternative embodiment, two isolating elements are disposed in a left side and right side on an interconnection position of the bus line where the data is applied to each of the bus lines. Followings are the description of the embodiments aforesaid, but not limit the scope of claims set forth in the present invention.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows the data bus structure for a driving device of a display.

FIG. 2 schematically shows a data bus structure which data is taken from the center of the device according to one embodiment of the present invention.

FIG. 3 schematically shows the detailed diagram of the data bus structure according to one embodiment of the present invention.

FIG. 4 schematically shows the comparison of estimated active current between conventional data bus and new data bus which data is taken from the center of device.

FIG. 5 schematically shows a data bus structure which data is taken from the left side of the device according to one embodiment of the present invention.

FIG. 6 schematically shows the comparison of estimated active current between conventional data bus and new data bus which data is taken from the left side or right side of the device.

FIG. 7 schematically shows a data bus a data bus structure which data is taken from the left upper side of the device.

FIG. 8 schematically shows the comparison of estimated active current between conventional data bus and new data bus which data is taken from the left upper side or right upper side of the device.

FIG. 9 schematically shows a data bus structure which data is taken from center of the device and two columns of transfer gates are used according to one embodiment of the present invention.

FIG. 10 schematically shows the detailed diagram of the data bus structure according to one embodiment of the present invention.

FIG. 11 schematically shows the comparison of estimated active current between conventional data bus and new data bus which data is taken from the center of device and two columns of transfer gates are used.

FIG. 12 schematically shows modified data bus structure based on the embodiment in FIG. 10.

FIG. 13 schematically shows the control logic circuits used in the present invention.

### DESCRIPTION OF THE EMBODIMENTS

The present invention proposes a data bus structure for a display driver, which is capable of low power consumption. In the proposed structure, data lines corresponding to a plurality of output channels are divided by alternatively inserting transfer gates. By controlling these transfer gates, current will be alternatively isolated from a portion of the bus and power consumption is significantly reduced. In the proposed structure, different function and settings can be determined in advance in consideration of where data is taken into the bus line.

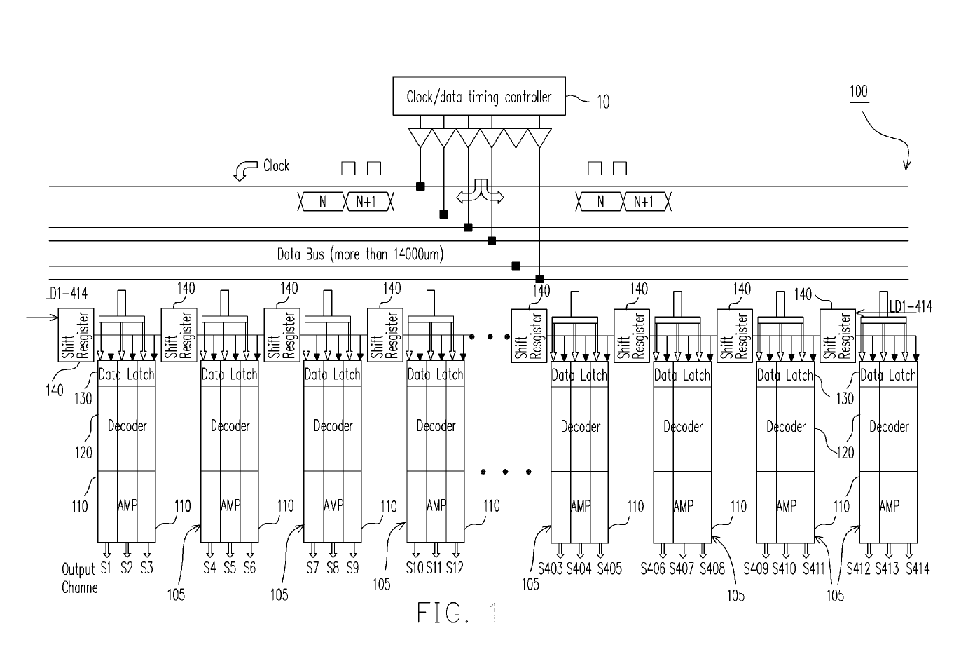

FIG. 1 schematically shows a data bus structure applied in a driving device 100 for a display. A clock/data timing controller 10 coupled to the data bus for providing a synchronous clock signal and image data to the driving device 100. The driving device 100 includes a plurality of data drivers 105, in which the number of the data drivers 105 depends on the display quality of the display. Each of the driver 105 includes an amplifiers (AMP) 110, a decoder 120, a data latch circuit 130 and a shift register 140. The data bus includes a plurality of data lines selectively coupled to the data latch circuits 130. There are 414 channels, from channel S1 to channel S414, for outputting data to a panel of the display in order to display image on the display. Every three channels are coupled to one data driver 105.

When the data driver 100 is initialized, there are two directions for the data latch circuits 130 to take data from the data bus, one direction is from channel S1 to channel S414, or the other direction is from channel S414 to channel S1. The direction that data on bus is taken into the data latch circuits 130 is determined by an external signal LD1_414. When the external signal LD1_414 is in a logic state “High”, the first data is taken into the first data latch circuit 130 for the channel S1, and the following data is sequentially taken into the data latch circuits 130 in a direction for channel S1 to channel S414. When the external signal LD1_414 is in a logic state “Low”, the direction of latching is from channel S414 to channel S1.

Receiving a synchronous signal from the Clock/Data timing controller 10, the image data is sequentially taken into the data latches under control of shift registers 140. The latched data is input to the decoders 120 used to translate data to coding information and then amplified by the amplifiers (AMP) 110 as signals for the output channels S1˜S414. It is seen that while data is taken by the data latch circuits 130, the entire data bus is always swung. Due to remaining consumption power for unused part of the data bus, power is waste, therefore.

A data bus structure applied to a driving device according to one embodiment of the present invention is proposed hereafter. Data lines in the data bus structure are divided into several sections by inserting isolating elements, for example, transfer gates. That is, each of the data lines is divided into these sections according to the interconnection positions between the data line and the channels. By such arrangement, the length of the bus line applied with current will be shortened and current will be alternatively isolated from a portion of the bus line by the inserted transfer gates and power consumption is significantly reduced.

The data bus structure can be implemented by several embodiments, according to the design choice and requirement. In an alternative embodiment, the data line is divided into several sections by inserting the transfer gates according to the interconnection positions between the data line and every M channels, M is determined as required. In another alternative embodiment, the position where the data is applied to the bus lines are considered to adjust the arrangement of the transfer gates inserted in the bus lines, for example, the data applied to the bus lines is to a center portion, to a left portion or to a right portion of the bus lines. In another alternative embodiment, two transfer gates are disposed in a left side and right side on an interconnection position of the bus line where the data is applied to each of the bus lines. Followings are the description of the embodiments aforesaid, but not limit the scope of claims set forth in the present invention.

### First Embodiment

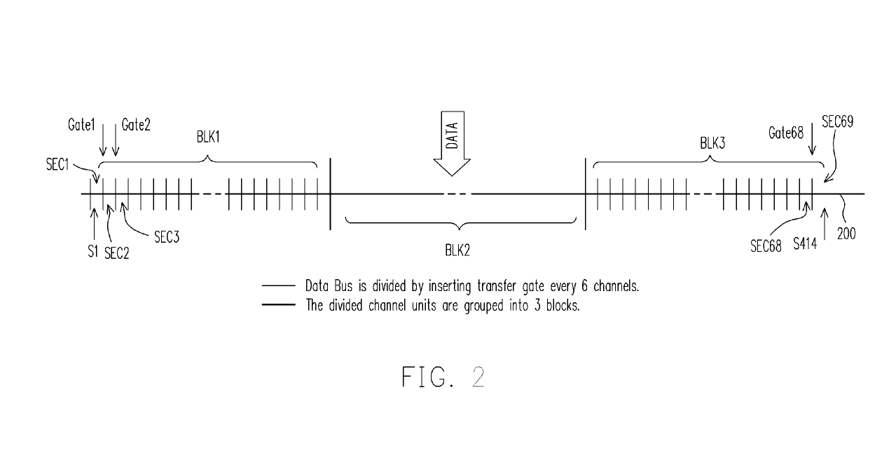

In case that the position where the data is applied is in a center portion of the bus line. One data line of the proposed data bus structure, which is applied to the driving device 100 of FIG. 1, is schematically illustrated in FIG. 2. The data line 200 coupled to 414 channels S1˜S414 through data drivers 105 is divided into 69 sections SEC1 to SEC69. That is, the data line 200 is divided into 69 sections according to the interconnection positions between the data line 200 and the every 6 channels of the channels S1˜S414. These sections SEC1 to SEC69 are grouped into 3 blocks, including a left block BLK1, a middle block BLK2, and a right block BLK3. Because that the data is taken from the center portion of the bus line, transfer gates are interposed every 6 channels in the left block BLK1 and the right block BLK3. It is not required to, but not limited thereto, interpose the transfer gates in the middle block BLK2.

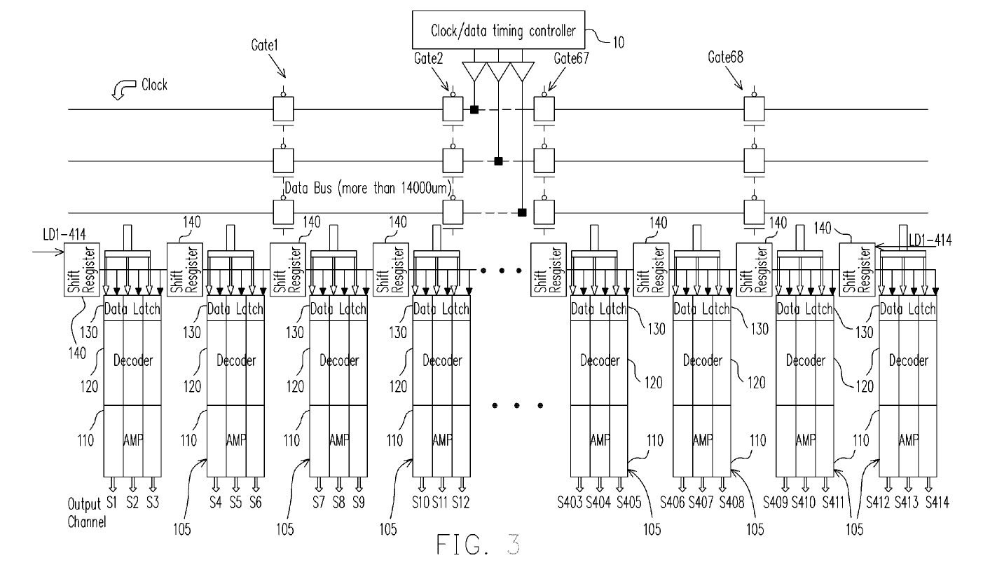

FIG. 3 schematically illustrates the data bus structure in detail according to the embodiment of the present invention mentioned above. The same components are using the same reference number as shown in FIG. 1. There are two directions for data latch circuits 130 in data drivers 105 to take data, from channel S1 to channel S414 or from channel S414 to channel S1. The direction that data on bus lines is taken into the data latch circuits 130 is determined by an external signal LD1_414 given, as explained above.

For explanation, the external signal LD1_414 is in a logic state of “high” and the data is taken from channel S1 to channel S414, for example. Before driving image data into the bus lines of the bus structure proposed in the preferred embodiment of the invention, an external trigger signal (Enable I/O, “EIO”) is used to initialize all transfer gates interposed in the bus lines. After two clocks of the EIO signal issued, the first data is taken into data latch circuit 130 for channel S1. After initialization, the transfer gates of the left block BLK1 are opened, that is, are turned on and both sides of the transfer gate are electrically connected to each other, and the transfer gates of the right block BLK3 are closed, that is, turned off. Controlled by the shift registers 140, data is taken by the data latch circuits 130 one by one.

The transfer gate Gate1 will be closed until the data latching by the data latch circuits 130 is completed for the six channels, including channel S1 to channel S6. Subsequently, the transfer gate Gate2 will be closed until the data latching by the data latch circuits 130 is completed for the six channels, including channel S7 to channel S12. With such a manner, the transfer gates Gate1, Gate2, Gate3, . . . , are sequentially closed until the data latching operation are completed for all channels corresponding to the left block BLK1.

Under control of the data latch circuits 130, data on the bus lines are latched sequentially for the channels corresponding to the middle block BLK2. Then the first transfer gate most close to the middle block BLK2 will be open sooner after. Until the data latching by the data latch circuits 130 is completed for the six channels, the next transfer gate close to the first transfer gate will be open for data latching. With such a manner, the transfer gates are sequentially closed until the data latching operation is completed for all channels corresponding to the right block BLK3.

As mentioned before, the middle block BLK2 does not have the transfer gates interposed therebetween. Data of the left block BLK1, the middle block BLK2 and the right block BLK3 will be taken sequentially by using latch circuits. Apparently, with all transfer gates of the left block BLK1 opened and all transfer gates of right block BLK3 closed, consumption power of the data bus can be reduced dramatically.

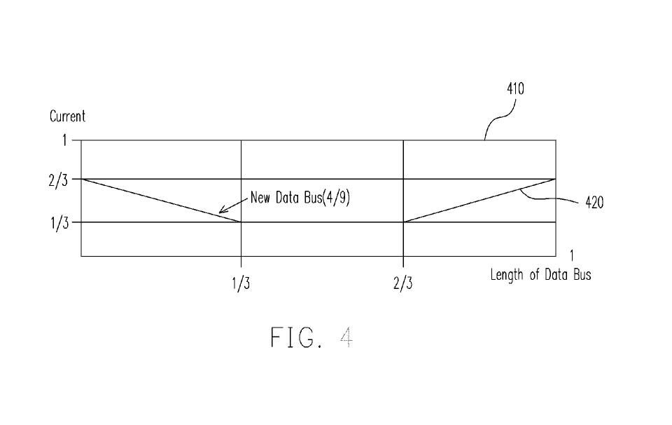

For simplicity, it is assumed that length of the data line in the data bus is “1”, and the active current on the data line of the data bus is “1”. Please refer to FIG. 4. By applying the data bus structure of the present invention, there is an active current drop between the data bus (the line with a reference number “410”) and the data bus of present invention (the line with a reference number “420”), particularly, for the middle block BLK2. For example, if the number of data lines on the data bus is 24, the capacitance of one data line is 1 pF, the operation voltage is 3.3 V, and the frequency is 100 MHz, the active current will be roughly about 3.52 mA, merely four-ninth of 7.92 mA in the data bus not applied with the invention.

By such arrangement, the length of the bus lines applied with current will be shortened and current will be alternatively isolated from a portion of the bus lines by the inserted transfer gates and power consumption is significantly reduced.

### Second Embodiment

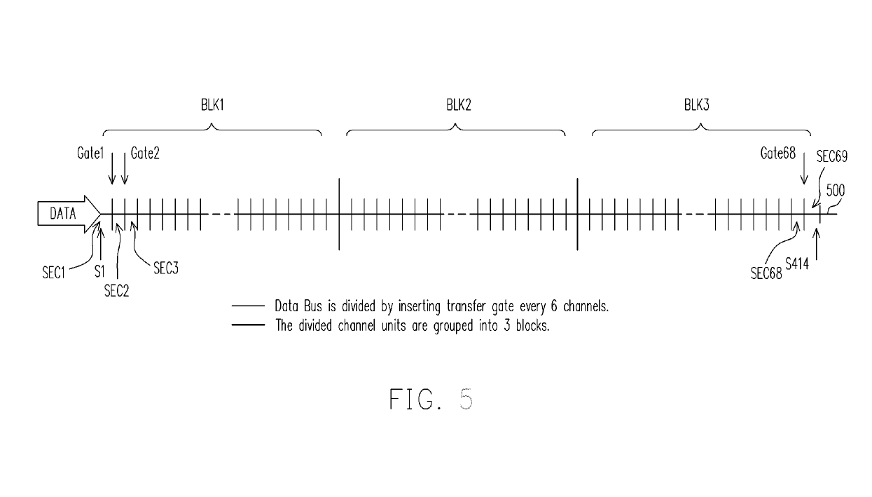

In case that the position where the data is applied is in a left portion of the bus line. One data line of the proposed data bus structure, which is applied to the driving device 100 of FIG. 1, is schematically illustrated in FIG. 5. The data line 500 coupled to channels S1˜S414 through data drivers 105 is divided into 69 sections SEC1 to SEC69, which is the same as shown in FIG. 2. These sections SEC1 to SEC69 are grouped into 3 blocks, including a left block BLK1, a middle block BLK2, and a right block BLK3. Transfer gates are interposed every 6 channels in these blocks, including the left block BLK1, the middle block BLK2 and the right block BLK3.

The data is taken from channel S1 to channel S414. Before driving image data into the bus lines of the bus structure proposed in the preferred embodiment of the invention, the external trigger signal is used to initialize all transfer gates interposed in the bus lines. After two clocks of the EIO signal issued, the first data is taken into data latch circuit 130 for channel S1. After initialization, the transfer gates in the left block BLK1, the middle block BLK2 and the right block BLK3 are all closed, that is, are turned off and both sides of the transfer gate are not electrically connected to each other. Controlled by the shift registers 140, data is taken by the data latch circuits 130 one by one.

The transfer gate Gate1 will be open until the data latching by the data latch circuits 130 is completed for the six channels, including channel S1 to channel S6. Subsequently, the transfer gate Gate2 will be open until the data latching by the data latch circuits 130 is completed for the six channels, including channel S7 to channel S12. With such a manner, the transfer gates Gate1, Gate2, Gate3, . . . , Gate68, and Gate69 are sequentially closed until the data latching operation are completed for all channels corresponding to the left block BLK1, the middle block BLK2 and the right block BLK3.

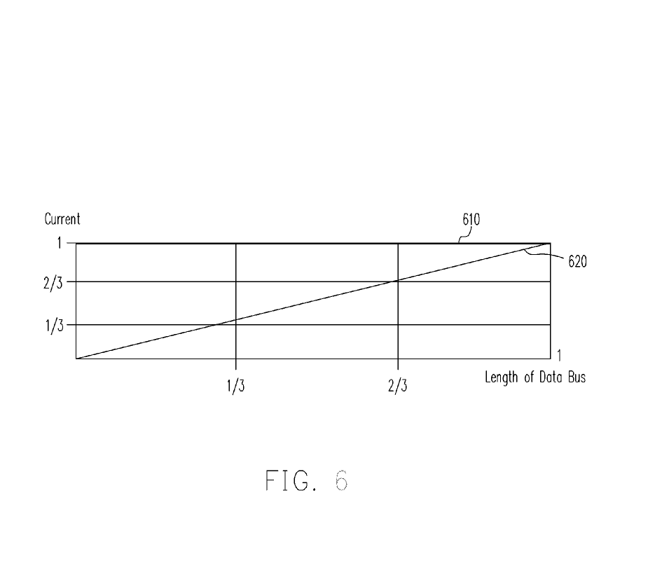

Please refer to FIG. 6, it is assumed that length of the data line in the data bus is “1”, and the active current on the data line of the data bus is “1.” By applying the data bus structure of the present invention, the active current on the data lines of present invention (the line with a reference number “620”) is increasing linearly during the data latching. Compared with the data lines with a conventional bus structure (the line with a reference number “610”), the active current in the data line of the present invention will be roughly ½ of current in the data bus not applied with the invention. The length of the bus lines applied with current will be shortened and current will be alternatively isolated from a portion of the bus lines by the inserted transfer gates and power consumption is significantly reduced.

### Third Embodiment

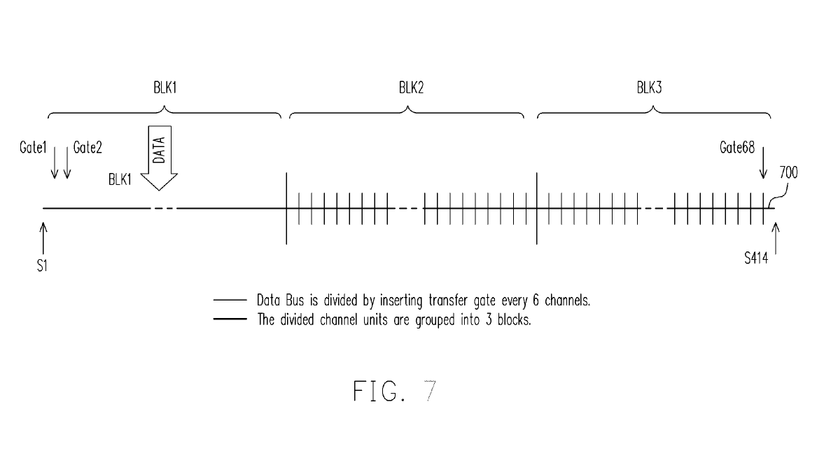

In case that the position where the data is applied is form the left upper side of the bus lines. One data line of the proposed data bus structure, which is applied to the driving device 100 of FIG. 1, is schematically illustrated in FIG. 7. The data line 700 coupled to 414 channels S1˜S414 through data drivers 105 is divided into 69 sections SEC1 to SEC69, the same manner as shown in FIG. 2. These sections SEC1 to SEC69 are grouped into 3 blocks, including a left block BLK1, a middle block BLK2, and a right block BLK3. Because that the data is taken from the left upper side of the bus lines, transfer gates are interposed every 6 channels in the middle block BLK2 and the right block BLK3.

After initialization of data latching, the transfer gates of the middle block BLK2 and the right block BLK3 are closed, that is, are turned off and both sides of the transfer gate are not electrically connected to each other. Controlled by the shift registers 140, data is taken by the data latch circuits 130 one by one.

After the data is latched and completed for all of the channels corresponding to the left block BLK1, the first transfer gate in the middle block BLK2, which is the most close to the left block BLK1, will be closed until the data latching by the data latch circuits 130 is completed for the six channels. Subsequently, the transfer gate next to the first transfer gate in the middle block BLK2 will be closed until the data latching by the data latch circuits 130 is completed for the six channels. With such a manner, the transfer gates the middle block BLK2 and the right block BLK3 are sequentially closed.

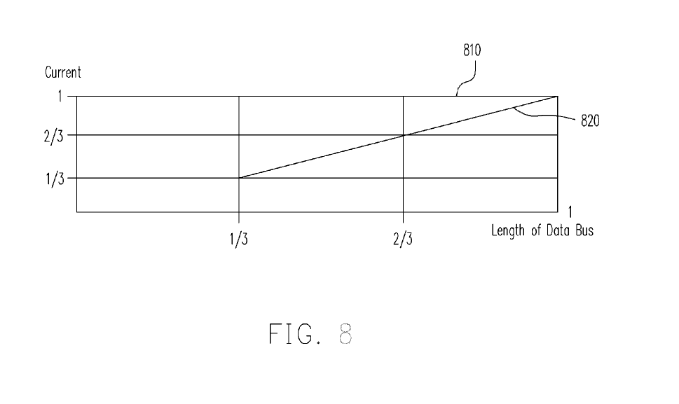

Please refer to FIG. 8, it is assumed that length of the data line in the data bus is “1”, and the active current on the data line of the data bus is “1.” By applying the data bus structure of the present invention, the active current on the data lines of present invention (the line with a reference number “820”) is fixed during the data latching for the channels corresponding to the left block BLK1 and then increasing linearly during the data latching for the channels corresponding to the middle block BLK2 and the right block BLK3. Compared with the data lines with a conventional bus structure (the line with a reference number “810”), the active current in the data line of the present invention will be roughly 5/9 (five-ninth) of current in the data bus not applied with the invention. The length of the bus lines applied with current will be shortened and current will be alternatively isolated from a portion of the bus lines by the inserted transfer gates and power consumption is significantly reduced.

### Fourth Embodiment

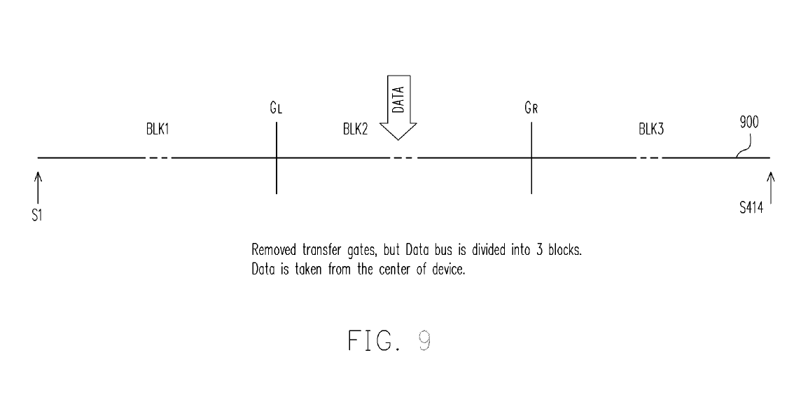

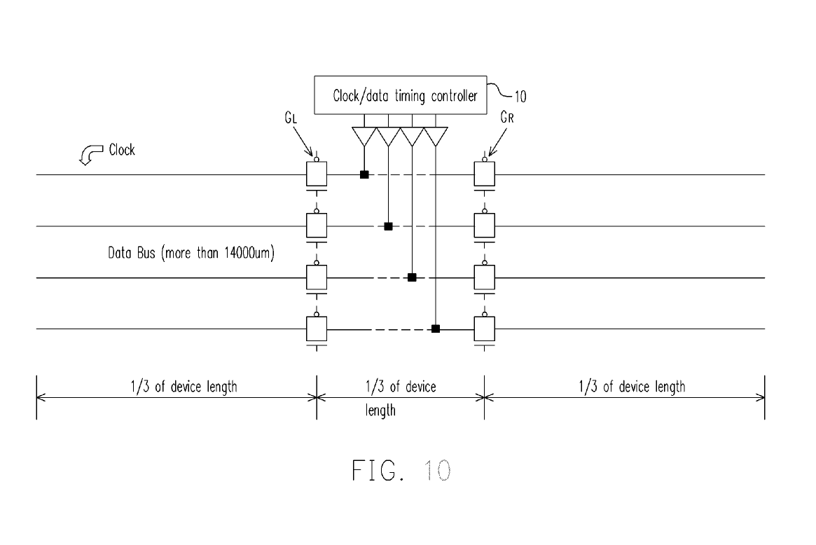

In case that the data is applied to a center portion of the bus line, one data line of the proposed data bus structure, which is applied to the driving device 100 of FIG. 1, is schematically illustrated in FIG. 9. The data line 900 coupled to 414 channels S1˜S414 through data drivers 105 is divided into 3 blocks, including a left block BLK1, a middle block BLK2, and a right block BLK3. Transfer gates are interposed between these blocks, including a left transfer gate GL interposed between the left block BLK1 and the middle block BLK2, and a right transfer gate GR interposed between the middle block BLK2 and the right block BLK3. FIG. 10 schematically illustrates the data bus structure in detail according to the embodiment of the present invention mentioned above. Transfer gates are interposed between these blocks in each of the data lines, including a left transfer gate GL interposed between the left block BLK1 and the middle block BLK2, and a right transfer gate GR interposed between the middle block BLK2 and the right block BLK3.

After initialization before starting to proceed with data latching, the left transfer gate GL is opened, that is, are turned on and both sides of the transfer gate are electrically connected to each other, and the right transfer gate GR is closed, that is, turned off. Controlled by the shift registers 140, data is taken by the data latch circuits 130 one by one. The left transfer gate GL will be closed until the data latching by the data latch circuits 130 is completed for all of the channels corresponding to the left block BLK1.

Under control of the data latch circuits 130, data on the bus lines are latched sequentially for the channels corresponding to the middle block BLK2. Then the right transfer gate GR will be open sooner after. Then the data latching by the data latch circuits 130 is completed for all of the channels corresponding to the right block BLK3.

As mentioned before, data of the left block BLK1, the middle block BLK2 and the right block BLK3 will be taken sequentially by using latch circuits 130. Apparently, with the left transfer gate GL is open and the right transfer gate GR is closed, consumption power of the data bus can be reduced dramatically.

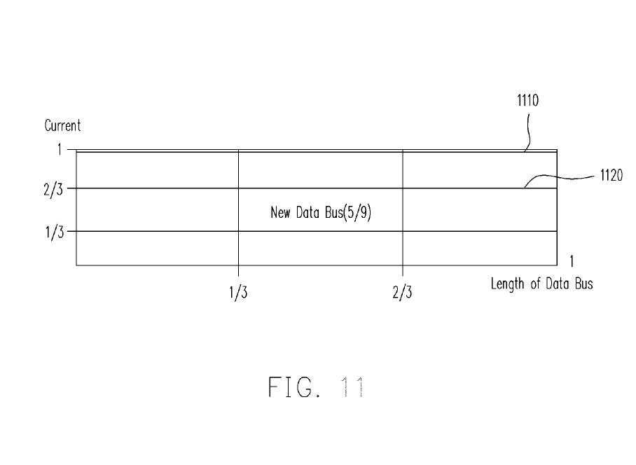

Please refer to FIG. 11, it is assumed that length of the data line in the data bus is “1”, and the active current on the data line of the data bus is “1.” By applying the data bus structure of the present invention, the active current on the data lines of present invention (the line with a reference number “1120”) is fixed value (⅔) during the data latching for the channels corresponding to the left block BLK1 and then is decreased to a fixed value (⅓) during the data latching for the channels corresponding to the middle block BLK2, and then is increased to a fixed value (⅔) during the data latching for the channels corresponding to the right block BLK3.

Compared with the data lines with a conventional bus structure (the line with a reference number “1110”), the active current in the data line of the present invention will be roughly 5/9 (five-ninth) of current in the data bus not applied with the invention. The length of the bus lines applied with current will be shortened and current will be alternatively isolated from a portion of the bus lines by the inserted transfer gates and power consumption is significantly reduced.

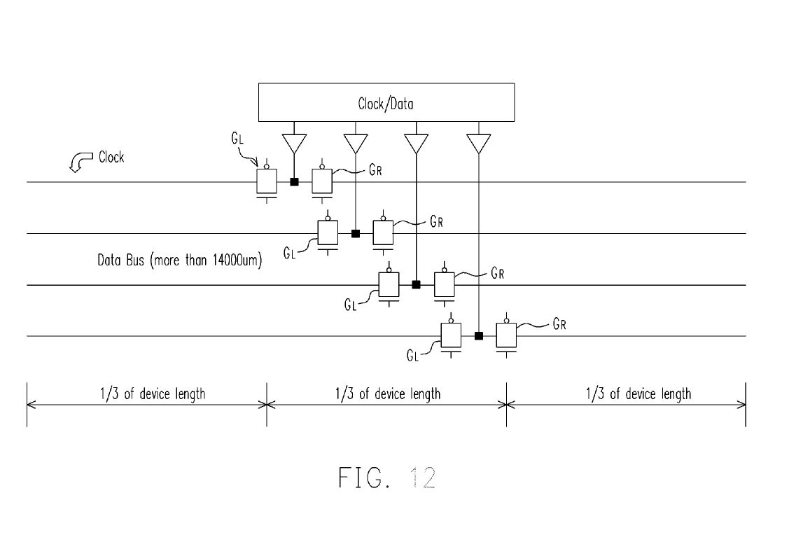

FIG. 12 schematically shows another data bus structure according to the fourth embodiment of the present invention. The modified data bus structure is based on the embodiment of the present invention shown in FIG. 10. Please refer to FIG. 10 and FIG. 12 at the same time. The differences between FIG. 12 and FIG. 10 are the location of the left transfer gates GL and the right transfer gates GR transfer gates.

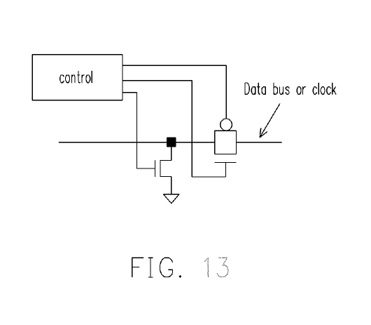

FIG. 13 schematically show control logic circuits used in the above embodiments and the diagram of control logic arrangement for N blocks, respectively. The control logic circuits can be used for controlling the logic status of the transfer gates as mentioned above. The used control logic can be a combination of N-MOS and P-MOS transistors connected to the data bus or clock, and one terminal of control logic can be grounded, as shown in FIG. 13.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A data bus structure for a driving device of a display, the data bus structure comprising:
a plurality of data lines, corresponding to a plurality of output channels of said driving device; and
a plurality of isolating elements, wherein said data lines are divided by alternatively inserting said isolating elements, by controlling said isolating elements, current is alternatively isolated from a portion of said bus line during data latching operation of said driving device.

2. The data bus structure as claimed in claim 1, wherein said data lines in said data bus structure are divided into a plurality of sections by inserting said isolating elements, wherein each of said data lines is divided into said sections according to interconnection positions between said data line and said channels.

3. The data bus structure as claimed in claim 2, wherein said data line is divided into said sections by inserting said isolating elements according to the interconnection positions between said data line and every M channels, M is a predetermined integer.

4. The data bus structure as claimed in claim 2, wherein a position where image data desired to be display is applied to said bus lines are considered to adjust the arrangement of said isolating elements inserted in said bus lines.

5. The data bus structure as claimed in claim 4, wherein if said position where said image data is applied is in a center portion of said bus line, said sections are grouped into three blocks, including a left block, a middle block, and a right block, wherein said image data is taken from said center portion of said bus line, said isolating elements are interposed every M channels in said left block and said right block.

6. The data bus structure as claimed in claim 4, wherein if said position where said image data is applied is in a left portion of the bus line, said sections are grouped into three blocks, including a left block, a middle block, and a right block, wherein said isolating elements are interposed every M channels in said left block, said middle block and said right block.

7. The data bus structure as claimed in claim 4, wherein if said position where said image data is applied is in a left upper side of said bus line, said sections are grouped into three blocks, including a left block, a middle block, and a right block, wherein said image data is taken from said left upper side of said bus line, said isolating elements are interposed every M channels in said middle block and said right block.

8. The data bus structure as claimed in claim 4, wherein said sections are grouped into three blocks, including a left block, a middle block, and a right block, wherein said isolating elements including a left isolating element interposed between the left block and the middle block, and a right isolating element interposed between the middle block and the right block.

9. Driving method applied upon a data bus structure for a driving device of a display, where the data bus structure comprising a plurality of data lines, connecting to a plurality of output channels of said driving device, each of the data lines is divided into a first portion, a second portion and a third portion according to said output channels of said driving device, the driving method comprising:
after initialization of data latching operation of said driving device, applying current to said first portion and said second portion of said bus lines and concurrently isolating said current from said third portion of said bus lines;
after data latching operation for said channels connected to said first portion of said bus lines is completed, applying current to said second portion of said bus lines and concurrently isolating said current from said first portion and said third portion of said bus lines; and
after data latching operation for said channels connected to said second portion of said bus lines is completed, applying current to said second portion and said third portion of said bus lines and concurrently isolating said current from said first portion until said data latching operation for said channels connected to said third portion of said bus lines is completed.

10. The driving method as claimed in claim 9, wherein said first portion of the bus line is divided into a plurality of sections by inserting isolating units every M channels, M is a predetermined integer, data latching operation for said channels corresponding to said first portion of said bus lines are completed sequentially every M channels and said sections in which said data latching operation is completed are also sequentially isolated from applying said current by controlling said isolating units.

11. The driving method as claimed in claim 9, wherein said third portion of the bus line is divided into a plurality of sections by inserting isolating units every M channels, M is a predetermined integer, data latching operation for said channels corresponding to said third portion of said bus lines are completed sequentially every M channels and said sections in which said data latching operation is completed are also sequentially isolated from applying said current by controlling said isolating units.

12. Driving method applied upon a data bus structure for a driving device of a display, where the data bus structure comprising a plurality of data lines, connecting to a plurality of output channels of said driving device, each of the data lines is divided into a first portion, a second portion and a third portion according to said output channels of said driving device, the driving method comprising:
after initialization of data latching operation of said driving device, applying current to said first portion of said bus lines and concurrently isolating said current from said second portion said and third portion of said bus lines;
after data latching operation for said channels connected to said first portion of said bus lines is completed, applying current to said first portion and said second portion of said bus lines and concurrently isolating said current from said third portion of said bus lines; and
after data latching operation for said channels connected to said second portion of said bus lines is completed, applying current to said first portion, said second portion and said third portion of said bus lines until said data latching operation for said channels connected to said third portion of said bus lines is completed.

13. The driving method as claimed in claim 12, wherein said first portion of the bus line is divided into a plurality of first sections by inserting isolating units every M channels, M is a predetermined integer,
data latching operation for said channels corresponding to said first portion of said bus lines are completed sequentially every M channels from said first channel of said channels to said channel close to a position between said first portion and said second portion, and said first sections in which said data latching operation is completed are conducted to said current by controlling said isolating units.

14. The driving method as claimed in claim 12, wherein said second portion of the bus line is divided into a plurality of second sections by inserting isolating units every M channels, M is a predetermined integer,
data latching operation for said channels corresponding to said second portion of said bus lines are completed sequentially every M channels from said channel close to a first position between said first portion and said second portion to said channel close to a second position between said second portion and said third portion, and said sections in which said data latching operation is completed are conducted to said current by controlling said isolating units.

15. The driving method as claimed in claim 12, wherein said second portion of the bus line is divided into a plurality of third sections by inserting isolating units every M channels, M is a predetermined integer,
data latching operation for said channels corresponding to said third portion of said bus lines are completed sequentially every M channels from said channel close to a first position between said second portion and said third portion to said last channel of said channels, and said sections in which said data latching operation is completed are conducted to said current by controlling said isolating units.
